(19) United States
(12) Patent Application Publication
(10) Pub. No.: US 2025/0202585 A1
(43) Pub. Date: Jun. 19, 2025

(54) CONNECTIVITY INDICATORS IN COMMUNICATION SYSTEMS

(71) Applicant: MELLANOX TECHNOLOGIES, LTD., Yokneam (IL)

(72) Inventors: Dimitrios KALAVROUZIOTIS, Papagou (GR); Paraskevas BAKOPOULOS, Ilion (GR); Nikolaos ARGYRIS, Zografou (GR); Ioannis (Giannis) PATRONAS, Piraeus (GR); Elad MENTOVICH, Tel Aviv (IL); James Stephen FIELDS, JR., Santa Fe, NM (US); Lisa YU, Cupertino, CA (US)

(73) Assignee: MELLANOX TECHNOLOGIES, LTD., Yokneam (IL)

(21) Appl. No.: 18/680,404

(22) Filed: May 31, 2024

(30) Foreign Application Priority Data
Dec. 14, 2023 (GR) 20230101037

(51) Int. Cl. H04B 10/27; H04B 10/25; H04B 10/40

(52) U.S. Cl. CPC H04B 10/27; H04B 10/25; H04B 10/40

(57) ABSTRACT

Apparatus, systems, and methods are provided that indicate the presence of optical connectivity in optical communication implementations. An example system includes a first optical transceiver and a first optical communication medium defining a first end connected with the first optical transceiver and a second end opposite the first end. The system further includes a first patch panel including one or more panel ports where a first panel port of the first patch panel connects with the second end of the first optical communication medium. The system also includes a first connection indication element that indicates the presence of an optical path between the first optical transceiver and the first patch panel in an instance in which the first optical transceiver is optically coupled with the first patch panel via the first optical communication medium.

### CROSS-REFERENCE TO RELATED APPLICATIONS

This application claims priority to Greek patent application No. 20230101037, filed Dec. 14, 2023, the entire contents of which application are hereby incorporated by reference.

### TECHNOLOGICAL FIELD

Example embodiments of the present disclosure relate generally to network communication systems and, more particularly, to mechanisms for indicating the presence of optical connectivity in optical communication implementations.

### BACKGROUND

Communication networks, systems, channels, and the like are employed in a variety of applications in order to transmit data from one location to another. For example, a collection of computing devices (e.g., compute units) or networking switches (e.g., formed in racks or the like) in an optical communication network may be interconnected via optical transceivers and associated optical cables (e.g., optical fibers or the like). Applicant has identified a number of deficiencies and problems associated with networking systems and associated communication devices. Through applied effort, ingenuity, and innovation, many of these identified problems have been solved by developing solutions that are included in embodiments of the present disclosure, many examples of which are described in detail herein.

### BRIEF SUMMARY

Systems, apparatuses, and methods are disclosed herein for optical connectivity indicators in optical communication implementations. An example system may include a first optical transceiver and a first optical communication medium defining a first end configured to be connected with the first optical transceiver and a second end opposite the first end. The example system may further include a first patch panel including one or more panel ports where a first panel port of the first patch panel is configured to be connected with the second end of the first optical communication medium. The system may also include a first connection indication element configured to indicate the presence of an optical path between the first optical transceiver and the first patch panel in an instance in which the first optical transceiver is optically coupled with the first patch panel via the first optical communication medium.

In some embodiments, the system may further include a first computing device or first networking switch that includes one or more connections where a first connection of the first computing device or the first networking switch is configured to be connected with the first optical transceiver.

In some further embodiments, the first connection indication element may be configured to indicate the presence of the optical path between the first computing device or the first networking switch and the first patch panel in an instance in which the first optical transceiver is optically coupled with the first patch panel via the first optical communication medium.

In some embodiments, the system may further include at least one optical fiber configured for transmitting optical signals, at least one optical fiber configured for receiving optical signals, and a first pair of dark fibers forming a first optical loop.

In some further embodiments, the system may further include a second pair of dark fibers forming a second optical loop where the second optical loop may be associated with determination of the presence of an optical path between the first patch panel and one or more components associated with a second patch panel.

In some further embodiments, the first connection indication element may be configured to indicate the presence of the optical path between the first optical transceiver and the first patch panel in response to light supplied to the first pair of dark fibers forming the first optical loop.

In some further embodiments, the first patch panel may further include a first light source optically coupled with the first pair of dark fibers forming the first optical loop, a first light detection device coupled with the first pair of dark fibers forming the first optical loop, and a first microcontroller communicably coupled with the first light source and the first light detection device. The first microcontroller may be configured to determine the presence of the optical path between the first optical transceiver and the first patch panel.

In some still further embodiments, the first microcontroller may be configured to cause the first light source to emit light into the first pair of dark fibers and cause the first connection indication element to indicate the presence of an optical path between the first optical transceiver and the first patch panel in response to receipt of the emitted light by the first light detection device.

In some embodiments, the first connection indication element may be further configured to display a first indication state associated with an absence of the optical path between the first optical transceiver and the first patch panel and display a second indication state associated with the presence of the optical path between the first optical transceiver and the first patch panel.

In some embodiments, the first connection indication element may be defined by the first patch panel.

In some embodiments, the system may further include a second connection indication element configured to indicate the presence of an optical path between the first patch panel and one or more components associated with a second patch panel.

In some embodiments, the system may further include a second optical transceiver and a second optical communication medium defining a first end configured to be connected with the second optical transceiver and a second end opposite the first end. In such an embodiment, the system may further include a second patch panel including one or more panel ports where a first panel port of the second patch panel is configured to be connected with the second end of the second optical communication medium. In such an embodiment, the system may further include a third connection indication element configured to indicate the presence of an optical path between the second optical transceiver and the second patch panel in an instance in which the second optical transceiver is optically coupled with the second patch panel via the second optical communication medium. The system may further include a jumper cable configured to optically connect the first patch panel and the second patch panel.

In some further embodiments, the system may further include a second computing device or second networking switch including one or more connections where a first connection of the second computing device or the second networking switch is configured to be connected with the second optical transceiver.

In some further embodiments, the system may include at least one optical fiber configured for transmitting optical signals, at least one optical fiber configured for receiving optical signals, a first pair of dark fibers forming a first optical loop associated with determination of the presence of the optical path between the first patch panel and the first optical transceiver, and a second pair of dark fibers forming a second optical loop associated with determination of the presence of the optical path between the first optical transceiver and the second optical transceiver.

In some still further embodiments, the system may further include a second connection indication element of the first patch panel configured to indicate the presence of an optical path between the first patch panel and the second optical transceiver and a fourth connection indication element of the second patch panel configured to indicate the presence of an optical path between the second patch panel and the first optical transceiver.

An example patch panel may include one or more panel ports where a first panel port of the patch panel is configured to be connected with a second end of a first optical communication medium and wherein a first end of the first optical communication medium opposite the second end is configured to be connected with the first optical transceiver. The patch panel may further include a first connection indication element configured to indicate the presence of an optical path between the first optical transceiver and the first patch panel in an instance in which the first optical transceiver is optically coupled with the first patch panel via the first optical communication medium.

In some embodiments, the patch panel may further include a first light source optically coupled with a first pair of dark fibers of the first optical transceiver forming a first optical loop, a first light detection device coupled with the first pair of dark fibers of the first optical transceiver forming the first optical loop, and a first microcontroller communicably coupled with the first light source and the first light detection device and configured to determine the presence of the optical path between the first optical transceiver and the first patch panel.

In some embodiments, the first connection indication element may be further configured to display a first indication state associated with an absence of the optical path between the first optical transceiver and the first patch panel and display a second indication state associated with the presence of the optical path between the first optical transceiver and the first patch panel.

In some embodiments, the patch panel may further include a second connection indication element configured to indicate the presence of an optical path between the first patch panel and one or more components associated with a second patch panel.

In some embodiments, the first optical transceiver may be further connected with a first computing device or first networking switch including one or more connections such that the first connection indication element is further configured to indicate the presence of the optical path between the first computing device or the first networking switch and the first patch panel in an instance in which the first optical transceiver is optically coupled with the first patch panel via the first optical communication medium.

The above summary is provided merely for purposes of summarizing some example embodiments to provide a basic understanding of some aspects of the present disclosure. Accordingly, it will be appreciated that the above-described embodiments are merely examples and should not be construed to narrow the scope or spirit of the disclosure in any way. It will be appreciated that the scope of the present disclosure encompasses many potential embodiments in addition to those here summarized, some of which will be further described below.

### BRIEF DESCRIPTION OF THE DRAWINGS

Having described certain example embodiments of the present disclosure in general terms above, reference will now be made to the accompanying drawings. The components illustrated in the figures may or may not be present in certain embodiments described herein. Some embodiments may include fewer (or more) components than those shown in the figures.

FIG. 1 illustrates example datacenter racks supporting computing devices and/or networking switches for implementing one or more embodiments of the present disclosure;

FIG. 2 illustrates an example direct connection between computing devices and/or networking switches;

FIG. 3A illustrates a front view of an example patch panel according to one or more embodiments of the present disclosure;

FIG. 3B illustrates a partial cross-sectional view of the example patch panel of FIG. 3A according to one or more embodiments of the present disclosure;

FIG. 4 illustrates an example optical transceiver according to one or more embodiments of the present disclosure;

FIG. 5 illustrates an example system with an optical transceiver having a single dark fiber pair prior to connection according to one or more embodiments of the present disclosure;

FIG. 6 illustrates the example system of FIG. 5 with a connection between an example first patch panel and first computing device of the system according to one or more embodiments of the present disclosure;

FIG. 7 illustrates the example system of FIGS. 5-6 with a connection between an example second patch panel and second computing device of the system according to one or more embodiments of the present disclosure;

FIG. 8 illustrates the example system of FIGS. 5-7 with a connection between the first patch panel and the second patch panel according to one or more embodiments of the present disclosure;

FIG. 9 illustrates an example system with an optical transceiver having multiple dark fiber pairs prior to connection according to one or more embodiments of the present disclosure;

FIG. 10 illustrates the example system of FIG. 9 with a connection between an example first patch panel and first computing device of the system according to one or more embodiments of the present disclosure;

FIG. 11 illustrates the example system of FIGS. 9-10 with a connection between the first patch panel and the second patch panel according to one or more embodiments of the present disclosure; and

FIG. 12 illustrates the example system of FIGS. 9-11 with a connection between an example second patch panel and second computing device of the system according to one or more embodiments of the present disclosure.

### DETAILED DESCRIPTION

### Overview

Embodiments of the present disclosure now will be described more fully hereinafter with reference to the accompanying drawings in which some but not all embodiments are shown. Indeed, the present disclosure may be embodied in many different forms and should not be construed as limited to the embodiments set forth herein; rather, these embodiments are provided so that this disclosure will satisfy applicable legal requirements. Like numbers refer to like elements throughout. Furthermore, as would be evident to one of ordinary skill in the art in light of the present disclosure, the terms “substantially” and “approximately” indicate that the referenced element or associated description is accurate to within applicable engineering tolerances.

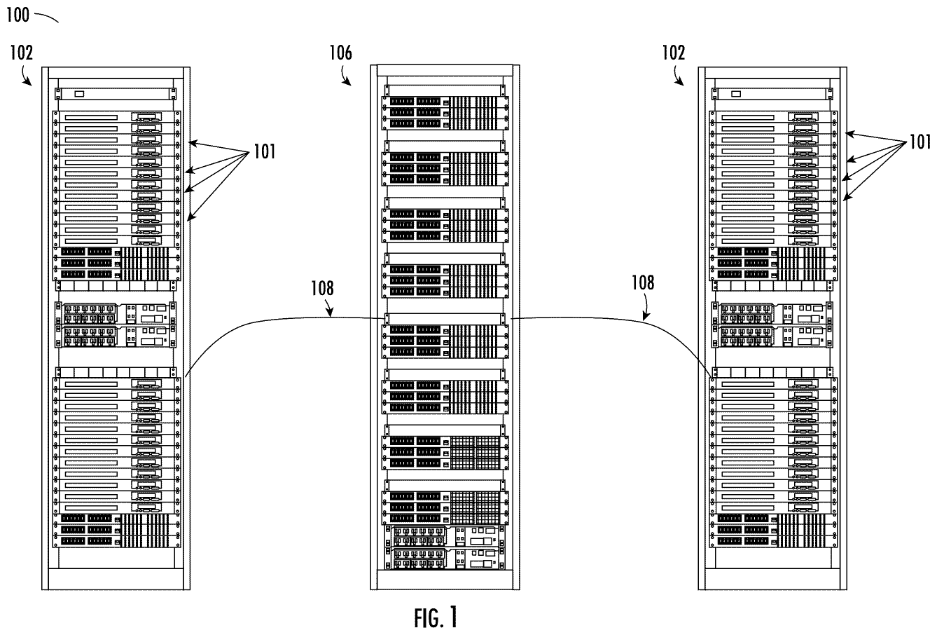

As described above, communication networks, systems, channels, and the like are employed in a variety of applications in order to transmit data from one location to another. With reference to FIG. 1, for example, a datacenter 100 or other networking environment (e.g., datacom, telecom, and/or other similar data/communication transmission networks), may leverage numerous electronic or computing components (e.g., CPUs, GPUs, DPUs, memory devices, etc.) to perform the operations associated with these environments. The example datacenter installation 100 (e.g., installation 100) of FIG. 1 may include a plurality of racks 102 supporting or otherwise formed of one or more computing devices (e.g., compute boxes) or networking switches 101 (e.g., servers, computing modules, GPU modules, optoelectronic devices, etc.). As shown, the computing devices or networking switches 101 may be communicably coupled within a particular datacenter rack 102 (e.g., an intra-rack connection) and/or between racks 102 (e.g., an inter-rack connection). In some instances, these connections may be established via one or more optical communication techniques, such as via one or more optical cables 108 (e.g., optical fibers or other optical communication mediums). Although described hereinafter with reference to example optical communication implementations, the present disclosure contemplates that the connection indication techniques of the embodiments described herein may be applicable to device communication of any type. As shown, FIG. 1 also illustrates a segmented fiber optic connectivity scheme as would be evident to one of ordinary skill in the art; however, the present disclosure contemplates that the connection indication mechanisms and techniques described herein may be applicable to connectivity schemes of any type, such as co-packaged optics (CPO), mid-board optics, near-package optics, etc.

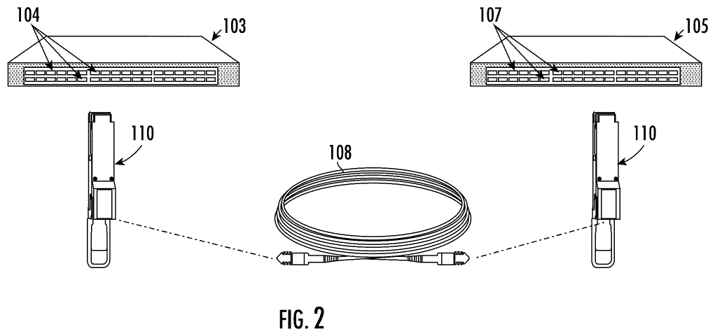

With reference to FIG. 2, in some connectivity schemes, optical communication cables 108 (e.g., a Multi-fiber Push On (MPO)-12, MP-16, etc. jumper cable or the like) may be connected to optical transceivers 110 disposed on opposing ends of the cable 108. Each of these optical transceivers 110 may be optically connected with respective computing devices or networking switches 101. For example, one optical transceiver 110 may be optically connected with one or more connections 104 of a first computing device 103. Similarly, another optical transceiver 110 may optically connected with one or more connections 107 of a second computing device 105. As datacenter installations evolve to incorporate segmented optical connectivity schemes, such as those illustrated in FIG. 1, however, as opposed to the direct connection illustrated in FIG. 2, current solutions fail to properly reduce the number of rack-to-rack connections for an effective segmented scheme. Furthermore, these conventional systems rely upon full connection link bring-up (e.g., full connectivity and operation) in order to determine if proper optical connectivity is present.

In order to address these problems and others, the embodiments of the present disclosure introduce optical connectivity indicators to patch panels used to connect these systems, pods, etc. For example, a transceiver and associated optical cable may be attached to a compute unit or networking switch. The optical cable may then be attached to a patch panel that includes a connectivity indicator that may, for example, light up to verify the existence of an optical path (i.e., eliminate the possibility of non-mated connector, broken cable, etc.) without requiring a link bring-up. To implement this functionality, the dark fibers of an example optical transceiver (e.g., a pair of dark fibers of an MPO-12, MPO-16, etc. connector) may include an optical loop that is connected to a light source/photodiode and microcontroller of the patch panel. When the microcontroller causes the light source to emit light to the dark fibers forming the optical loop, the microcontroller may determine the presence of an optical path when the emitted light is received by the photodiode. This connectivity may further address connectivity between transceivers, compute units, networking switches, etc. of different racks that are connected via jumper cables. In such an example, multiple connectivity indicators may be used by respective patch panels to indicate the presence of inter/intra-rack optical paths. In doing so, the embodiments of the present disclosure operate to reduce the number of rack-to-rack connections in segmented fiber schemes (e.g., reduce rack-to-rack fibers) and isolate rack-level and pod-level fiber set up. As described herein, the pair of dark fibers of the example MPO receptacle that enable the optical path indication determinations of the present disclosure may be provided at various locations in the system (e.g., on the example front panel, at intermediate patch panels, etc.) based on the intended application of the systems described herein. Furthermore, the embodiments of the present disclosure may be applicable to multicore optical fiber (MCF) implementations in which MCFs are included at any location within the optical links described herein.

### Example Optical Connectivity Indication Systems

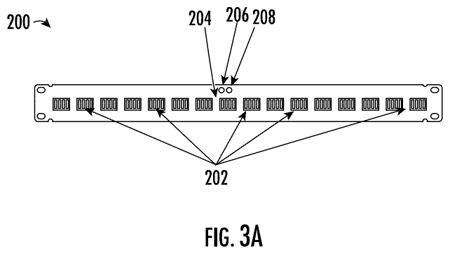

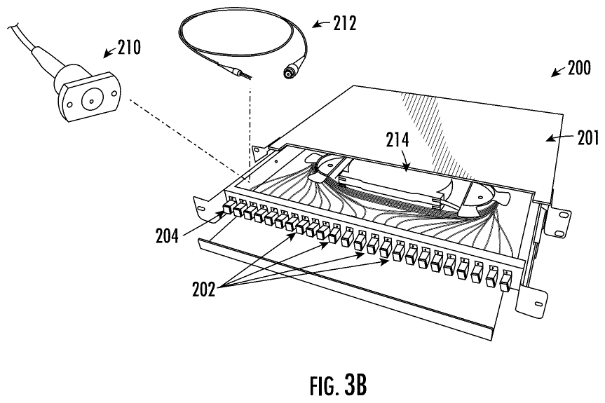

With reference to FIG. 3A, an example first patch panel 200 of the present disclosure is illustrated for use with the systems described herein. The first patch panel 200 may include one or more panel ports 202 that may be configured to be communicably coupled with one or more connectors of a communication medium (e.g., optical cable or the like). By way of example, the one or more panel ports 202 may be configured to receive at least a portion of an optical connector of an associated optical communication medium. As described hereinafter with reference to an example first panel port 204, the one or more panel ports 202 may include the first panel port 204 that is configured to be connected with a second end of a first optical communication medium. The present disclosure contemplates that the one or more panel ports 202 may be dimensioned (e.g., sized and shaped) to communicably couple (e.g., optically couple) the first patch panel 200 with an associated communication medium of any type based upon the intended application of the systems described herein. Furthermore, although described herein with reference to optical connectivity indication techniques associated with the first panel port 204, the present disclosure contemplates that the techniques described herein may be applicable to any of the panel ports 202 of the first patch panel 200 without limitation.

The first patch panel 200 may further include a first connection indication element 206 and/or a second connection indication element 208 that are configured to indicate the presence of respective optical paths as described hereafter. The first and/or second connection indication elements 206, 208 may refer to any mechanism for indicating (e.g., to a user or operator associated with the first patch panel 200) the presence or existence of an optical path. By way of a nonlimiting example, the connection indication elements 206, 208 may include one or more light sources that may display a particular color, pattern, and/or the like in the presence of an optical path. In some embodiments, the connection indication elements 206, 208 may be configured to display a first indication state (e.g., a first color) associated with an absence of the optical path between a first optical transceiver and the first patch panel 200 and display a second indication state (e.g., second color) associated with the presence of the optical path between the first optical transceiver and the first patch panel 200. Although described herein with reference to connection indication elements 206, 208 (e.g., a light source or the like) that are configured to provide a visual indication to a user or operator of the presence of an associated optical path (e.g., via respective colors or the like), the present disclosure contemplates that the connection indication elements 206, 208 may include any mechanism or structure (e.g., auditory indication, message presentation on mobile device or terminal, etc.) for providing this indication. As shown in FIG. 3A, the first patch panel 200 may, in some embodiments, define the first and/or the second connection indication elements 206, 208. The present disclosure, however, contemplates that the connection indication elements 206, 208 described herein may, in some embodiments, be located remotely from the first patch panel 200 (e.g., as part of a centralized connection terminal or the like).

As shown in FIG. 3B, the first patch panel 200 may include a housing 201 that is configured to at least partially support the various components of the first patch panel 200. The dimensions (e.g., size and shape) of the housing 201 may vary based upon the intended application of the first patch panel 200. By way of example, the housing 201 may be dimensioned so as to be received by a datacenter rack 102 in a datacenter installation 100. In order to implement the optical connectivity functionality described herein, the first patch panel may include a first light source 210 and a first light detection device 212 each coupled with the first panel port 204. The first light source 210 may include any device, structure, etc. configured to emit a light that may be received by an optical fiber. For example, the first light source 210 may include a light emitting diode (LED) configure to emit light. The first light detection device 212 may similarly include any device, structure, etc. configured to receive light or otherwise detect the presence of light that may be transmitted by an optical fiber. For example, the first light detection device 212 may include a photodiode (PD) configured to receive light, optical signals, etc. transmitted via an optical fiber. As would be evident to one of ordinary skill in the art in light of the present disclosure, each panel port 202 of the first panel 200 may include respective light sources and light detection devices.

The first patch panel 200 may further include a first microcontroller communicably coupled with the first light source 210 and the first light detection device 212. The first microcontroller 214 may, as described hereafter, be configured to determine the presence of the optical path between the first patch panel 200 and an associated optical transceiver optically coupled with the first panel port 204 of the one or more panel ports 202. By way of a non-limiting example, the first microcontroller 214 may receive data entries (e.g., a signal, transmission, etc.) from the first light detection device 212 that indicates that the light emitted by the first light source 210 was received (e.g., as transmitted by one or more optical fibers) by the first light detection device 212. In response, the first microcontroller 214 may, for example, cause the first connection indication element 206 to indicate the presence of an optical path. The present disclosure contemplates that the components (e.g., light sources, light detection devices, microcontrollers, etc.) described above and hereinafter with reference to the first patch panel 200 may be similarly applicable to other patch panels (e.g., a second patch panel 400) leveraged by the system.

The first microcontroller 214 (and other microcontrollers described herein) may include, be associated with or be in communication with one or more processors, memories, communication interfaces, and/or other circuitry components in order to perform the operations described herein. For example, the processor may be in communication with the memory via a bus for passing information among components of the microcontroller 214. The memory may be non-transitory and may include, for example, one or more volatile and/or non-volatile memories. In other words, for example, the memory may be an electronic storage device (e.g., a computer readable storage medium) comprising gates configured to store data (e.g., bits) that may be retrievable by a machine (e.g., a computing device like the processing circuitry). The memory may be configured to store information, data, content, applications, instructions, or the like for enabling the apparatus to carry out various functions in accordance with an example embodiment of the present disclosure.

The processor may be embodied as one or more of various hardware processing means such as a coprocessor, a microprocessor, a controller, a digital signal processor (DSP), a processing element with or without an accompanying DSP, or various other circuitry including integrated circuits such as, for example, an ASIC (application specific integrated circuit), an FPGA (field programmable gate array), a hardware accelerator, a special-purpose computer chip, or the like. As such, in some embodiments, the processing circuitry may include one or more processing cores configured to perform independently. A multi-core processing circuitry may enable multiprocessing within a single physical package. Additionally or alternatively, the processing circuitry may include one or more processors configured in tandem via the bus to enable independent execution of instructions, pipelining and/or multithreading.

In an example embodiment, the processor may be configured to execute instructions stored in the memory or otherwise accessible to the processor. Alternatively or additionally, the processing circuitry may be configured to execute hard coded functionality. As such, whether configured by hardware or software methods, or by a combination thereof, the processing circuitry may represent an entity (e.g., physically embodied in circuitry) capable of performing operations according to an embodiment of the present disclosure while configured accordingly. Thus, for example, when the processing circuitry is embodied as an ASIC, FPGA or the like, the processing circuitry may be specifically configured hardware for conducting the operations described herein. Alternatively, as another example, when the processor is embodied as an executor of instructions, the instructions may specifically configure the processor to perform the algorithms and/or operations described herein when the instructions are executed. However, in some cases, the processor may be a processor of a specific device configured to employ an embodiment of the present disclosure by further configuration of the processing circuitry by instructions for performing the algorithms and/or operations described herein. The processor may include, among other things, a clock, an arithmetic logic unit (ALU) and logic gates configured to support operation of the processing circuitry.

With continued reference to FIG. 3B, the first patch panel 200 may be configured for use in MCF implementations as described above. As would be evident to one of ordinary skill in the art in light of the present disclosure, a multicore optical fiber may refer to an optical fiber that includes multiple cores (or any structure through which light may propagate) within a single strand. By way of example, a MCF implementation may include or otherwise be associated with optical signal transmission of multiple transceivers (e.g., a first optical transceiver, a second optical transceiver, etc.) within the same MCF fiber. In order to implement MCFs, the first patch panel 200, in some embodiments, may aggregate fibers at a jumper cable, a conversion cable, and/or the like connecting the example first transceiver 300 to the patch panel 200 thereby resulting in more dense optical connectors on the side of the first patch panel 200. Additionally or alternatively, in some embodiments, fiber aggregation may occur at the connectors, such as by aggregating MPO12s to MPO72. As would be evident to one of ordinary skill in the art in light of the present disclosure, any type, configuration, standard, etc. of connector may be used by the patch panel 200. By way of a non-limiting example, 6xMPO12 to MPO72 fanout cables, or 3xMPO12 to MCF36, 3xMCF12 to MCF36, among others may be used. Although described herein with reference to the first patch panel 200, the present disclosure contemplates that any of the patch panels (e.g., second patch panel 400 or the like) used by the datacenter 100 may be configured to implement MCFs.

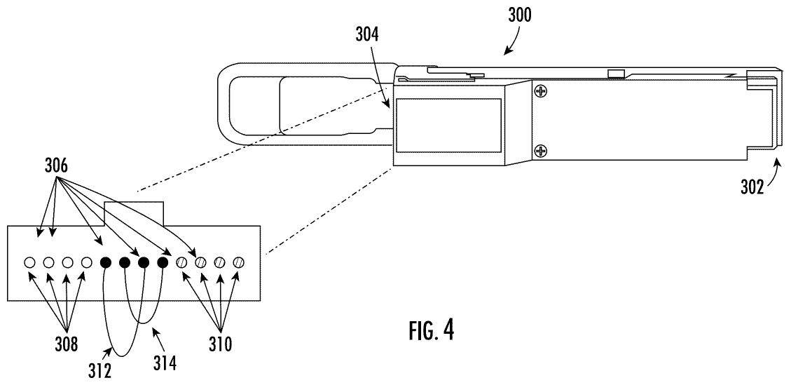

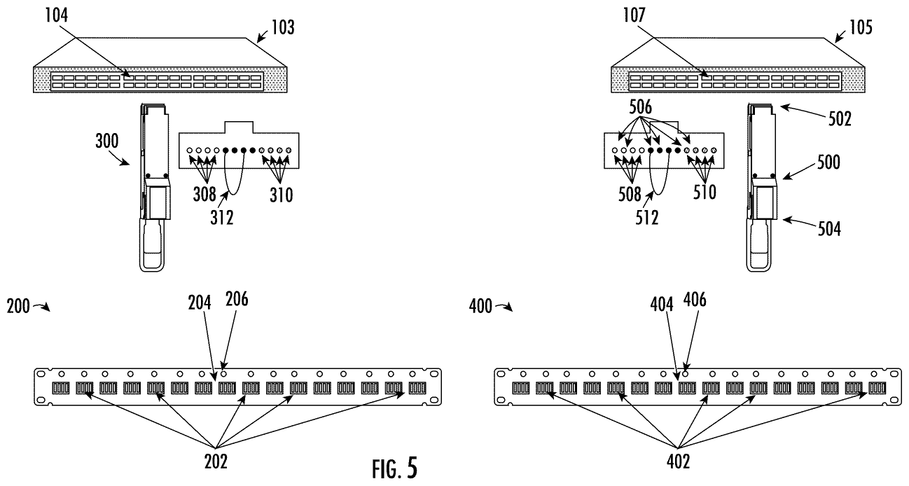

With reference to FIG. 4, an example first optical transceiver 300 is illustrated. As shown, the first optical transceiver 300 may define a first end 302 (e.g., an edge connector or the like) configured to optically couple the first optical transceiver with an example first computing device 103. By way of example, the first end 302 of the first optical transceiver 300 may be received by a first connection 104 (e.g., one of the one or more connections of the first computing device 103). The first optical transceiver 300 may further include a second end 304 opposite the first end that is configured to be optically coupled with an end (e.g., a first end) of a first optical communication medium (e.g., a first optical communication cable 316 in FIGS. 5-12). As would be evident to one of ordinary skill in the art in light of the present disclosure, the first optical transceiver 300 may include various optoelectronic components (e.g., lasers, photodiodes, etc.) to convert between electrical and optical signals so as to establish optical connectivity between networked components as described hereinafter. Furthermore, the present disclosure contemplates that the first optical transceiver 300 may include transceivers of any type (e.g., small form-factor pluggable (SFP), Quad Small Form Factor Pluggable (QSFP), QSFP+, QSFP28, QSFP-DD, Octal Small Form Factor Pluggable (OSFP), and/or the like). Although described herein with reference to the first optical transceiver 300, the present disclosure contemplates that any optical transceiver (e.g., a second optical transceiver 500 or the like) of the system may include the structure or components described herein.

The first optical transceiver 300 may include a plurality of optical fibers 306, such as in an MPO-12 configuration, in which least one optical fiber is configured for transmitting optical signals and at least one optical fiber is configured for receiving optical signals. As shown, the plurality of optical fibers 306 may include a plurality of optical fibers 308 configured for transmitting optical signals and a plurality of optical fibers 310 configured for receiving optical fibers. In the illustrate MPO-12 configuration, the plurality of optical fibers 306 may further include a first pair of dark fibers forming a first optical loop 312. In some embodiments, the plurality of optical fibers 306 may further include a second pair of dark fibers forming a second optical loop 314. As would be evident to one of ordinary skill in the art in light of the present disclosure, a “dark fiber” as described herein may refer to a connection that supports optical connectivity but is otherwise unused by the optical communication system for transmitting or receiving optical signals. Said differently, a dark fiber may refer to an optical communication medium that is capable of transmitting light but the light transmitted via the dark fiber does not encode underlying data (e.g., an optical signal), such as the optical signals of the optical fibers 308 and 310. The first and second pair of dark fibers 312 and 314 may form respective optical loops (e.g., loopbacks) such that light that is received at one end of the loopback (e.g., from the light source 210) may be directed along the optical loop 312 for receipt by the first light detection device 212. In such an embodiment, the first optical transceiver 300 may support or otherwise include the MPO connector and associated first and second pair of dark fibers 312 and 314 that form respective optical loops (e.g., loopbacks). Although described herein with reference to an example MPO-12 implementation, the present disclosure contemplates that the optical transceivers (e.g., the first optical transceiver 300, the second optical transceiver 500, etc.) of the present disclosure may include any number of optical fibers and/or dark fiber loopbacks (e.g., optical loops) based upon the intended application of the associated system.

As described above, in some embodiments, the pair of dark fibers 312 and 314 of the example MPO receptacle that enable the optical path indication determinations of the present disclosure may be provided at various locations in the system. For example, in some embodiments, such as a CPO implementation, the MPO receptacle that includes the pair of dark fibers 312 and 314 may be supported by the first patch panel 200 as opposed to the first optical transceiver 300. Said differently, the MPO receptacles described herein may be placed at any location (e.g., on the example front panel, at intermediate patch panels, etc.) based on the intended application of the systems of the present disclosure.

As described above, in some embodiments, the first optical transceiver 300 may be configured for use in MCF implementations. In order to implement MCFs, the first optical transceiver 300, in some embodiments, may include one or more optical fibers that contain multiple cores (or any structure through which light may propagate) within a single strand. By way of a non-limiting example, the first optical transceiver 300 may include a 13-core optical fiber, a portion of which cores may be dark fibers as described above. Said differently, at least a portion of the cores forming the MCF-based first optical transceiver 300 may be connections that support optical connectivity but are otherwise unused by the optical communication system for transmitting or receiving optical signals (e.g., a dark fiber) as defined above. Although described herein with reference to the first optical transceiver 300, the present disclosure contemplates that any of the optical transceivers (e.g., second optical transceiver 500 or the like) used by the datacenter 100 may be configured to implement MCFs. Furthermore, although described herein with reference to potential modifications to the first optical transceiver 300, the first patch panel 200, etc., the present disclosure contemplates that a conversion to MCF may occur at any location along the optical link that includes the first patch panel 200 and the first optical transceiver 300 based on the intended application of these devices.

### Optical Connectivity Operations

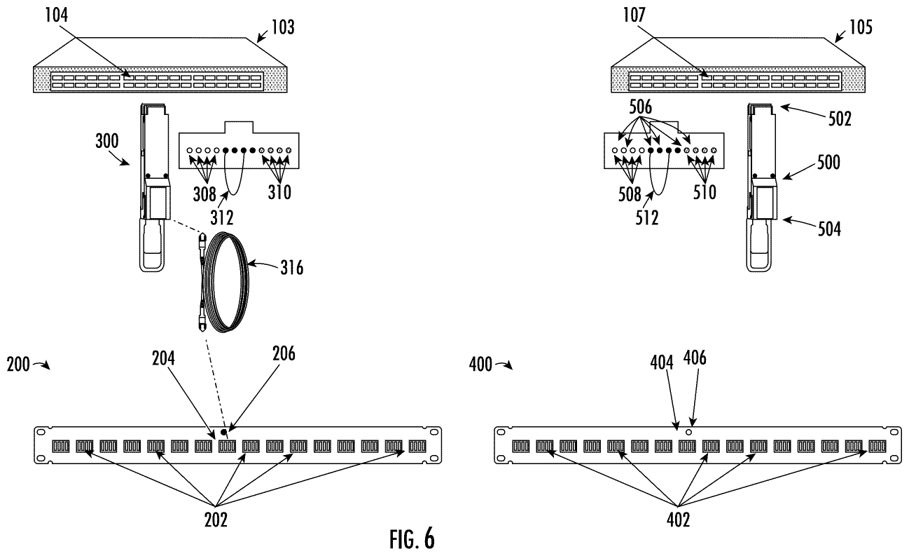

With reference to FIGS. 5-8, an example system with optical transceivers 300, 500 having a single dark fiber pair 312, 512 is illustrated prior to connection. As shown in FIGS. 5-6, the system may include a first optical transceiver 300 that includes a first end 302 and a second end 304 as described above with reference to FIG. 4. The system may further include a first optical communication medium 316 that defines a first end configured to be connected with the first optical transceiver 300 (e.g., at the second end 304 of the first optical transceiver 300) and a second end opposite the first end. The first optical transceiver 300, as described above, may include at least one optical fiber configured for transmitting optical signals 308, at least one optical fiber configured for receiving optical signals 310, and a first pair of dark fibers forming a first optical loop 312. The system may include a first patch panel 200 that includes one or more panel ports 202. As described above with reference to FIGS. 3A-3B, a first panel port 204 of the first patch panel 200 may be configured to be connected with the second end of the first optical communication medium 316 as illustrated hereafter. The first patch panel 200 may include the first light source 210, the first light detection device 212, and the first microcontroller 214 as described above. The system may include a first connection indication element 206 configured to indicate the presence of an optical path between the first optical transceiver 300 and the first patch panel 200 in an instance in which the first optical transceiver 300 is optically coupled with the first patch panel 200 via the first optical communication medium 316.

The system may similarly include a second optical transceiver 500 that includes a first end and a second end, and a second optical communication medium 516 that defines a first end configured to be connected with the second optical transceiver 500 (e.g., at the second end of the second optical transceiver 500) and a second end opposite the first end. The second optical transceiver 500 may, similar to the first optical transceiver 300, include at least one optical fiber configured for transmitting optical signals 508, at least one optical fiber configured for receiving optical signals 510, and a first pair of dark fibers forming a first optical loop 512. As above, the pair of dark fibers described herein with reference to the second optical transceiver 500 may be positioned at any location within the system (e.g., co-packaged optics (CPO), mid-board optics, near-package optics, etc.). The system may include a second patch panel 400 that includes one or more panel ports 402. A first panel port 404 of the second patch panel 400 may be configured to be connected with the second end of the second optical communication medium 516 as illustrated hereafter. The second patch panel 400 may include an associated light source, light detection device, and microcontroller as described above with reference to the first patch panel 200. The system may include a third connection indication element 406 configured to indicate the presence of an optical path between the second optical transceiver 500 and the second patch panel 400 in an instance in which the second optical transceiver 500 is optically coupled with the second patch panel 400 via the second optical communication medium 516.

As shown in FIG. 6, the first optical transceiver 300 may be optically coupled with the first optical communication medium 316 (e.g., a connection between the second end of the first optical transceiver 300 and the first end of the first optical communication medium 316). The second end of the first optical communication medium 316 may be optically coupled with the first panel port 204 of the first patch panel 200. The first end of the first optical transceiver 300 may be optically coupled with a first connection 104 of the first computing device 103 so as to establish an optical link or connectivity between the first patch panel 200 and the first computing device 103. In order to illustrate that the optical connection between the first patch panel 200 and the first computing device 103 is valid (e.g., properly coupled or the like) without bringing up (e.g., powering on, transmitting optical signals that encode data, etc.) the optical link, the components of the first patch panel 200 may cause perform an optical connection indication operation.

The first light source 210 may be optically coupled with the first pair of dark fibers forming the first optical loop 312, and the first light detection device 212 may also be coupled with the first pair of dark fibers forming the first optical loop 312 (e.g., on opposing fiber ends of the first optical loop 312). The first microcontroller 214 may cause the first light source 210 to emit light into the first pair of dark fibers 312 and cause the first connection indication element 206 to indicate the presence of an optical path between the first optical transceiver 300 and the first patch panel 200 in response to receipt of the emitted light by the first light detection device 212. For example, the first connection indication element 206 may change from a first color (e.g., red or the like) configured to indicate the absence of the optical path between the first optical transceiver 300 and the first patch panel 200 to a second color (e.g., green or the like) configured to indicate the presence of the optical path between the first optical transceiver 300 and the first patch panel 200.

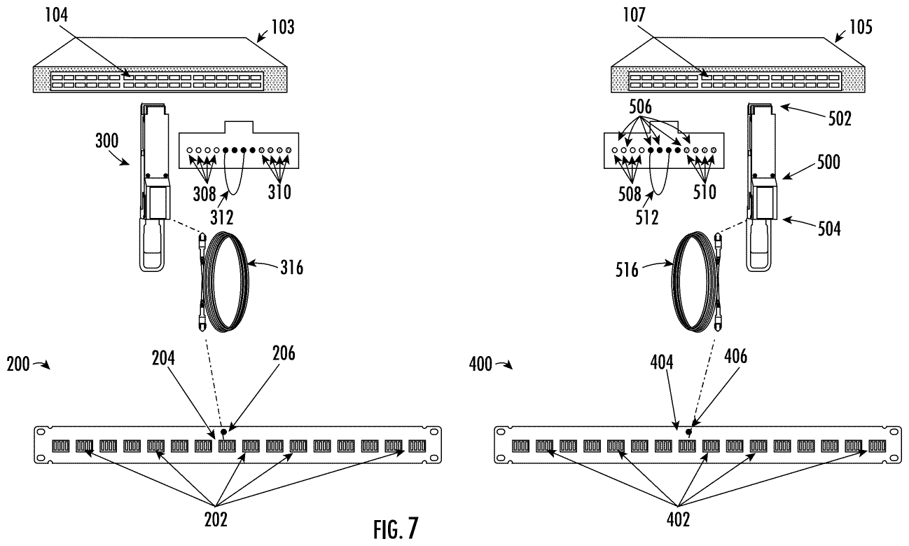

As shown in FIG. 7, the second optical transceiver 500 may be optically coupled with the second optical communication medium 516 (e.g., a connection between the second end of the second optical transceiver 500 and the first end of the second optical communication medium 516). The second end of the second optical communication medium 516 may be optically coupled with the first panel port 404 of the second patch panel 400. The first end of the second optical transceiver 500 may be optically coupled with a first connection 107 of the second computing device 105 so as to establish an optical link or connectivity between the second patch panel 400 and the second computing device 105. In order to illustrate that the optical connection between the second patch panel 400 and the first computing device 105 is valid (e.g., properly coupled or the like) without bringing up (e.g., powering on, transmitting optical signals that encode data, etc.) the optical link, the components of the second patch panel 400 may cause perform an optical connection indication operation.

A first light source of the second patch panel 400 may be optically coupled with the first pair of dark fibers forming the first optical loop 512 for the second optical transceiver 500, and a first light detection device of the second patch panel 500 may also be coupled with the first pair of dark fibers forming the first optical loop 512 (e.g., on opposing fiber ends of the first optical loop 512 of the second optical transceiver 500). A microcontroller of the second patch panel may cause the first light source to emit light into the first pair of dark fibers 512and cause the third connection indication element 406 to indicate the presence of an optical path between the second optical transceiver 500 and the second patch panel 400 in response to receipt of the emitted light by the light detection device. For example, the third connection indication element 406 may change from a first color (e.g., red or the like) configured to indicate the absence of the optical path between the second optical transceiver 500 and the second patch panel 400 to a second color (e.g., green or the like) configured to indicate the presence of the optical path between the second optical transceiver 500 and the second patch panel 400.

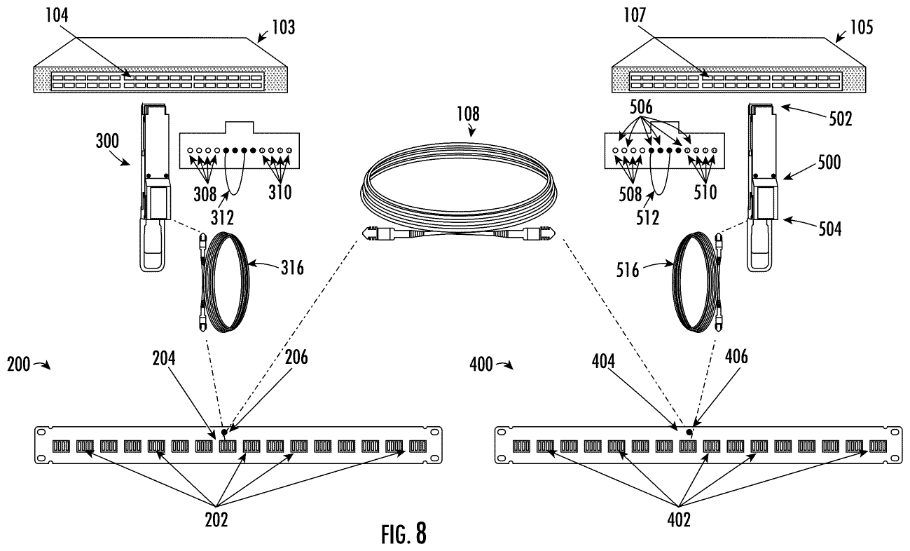

As shown in FIG. 8, a trunk cable 108 (e.g., an optical communication medium) may be optically connected with the first panel port 204 of the first patch panel 200 and the first panel port 404 of the second patch panel 400. In doing so, optical signals may be transmitted between the first patch panel 200 and the second patch panel 400. Furthermore, the configuration illustrated in FIG. 8 may represent a complete optical link between the first computing device 103 and the second computing device 105. For example, electrical signals generated by the second computing device 105 may be received by the second optical transceiver 500 and converted to optical signals that are transmitted via the second optical communication medium 516 to the second patch panel 400. The optical signals may be directed by the trunk cable 108 to the first patch panel 200 and provided to the first optical communication medium 316. The optical signals may be received by the first optical transceiver 300 and converted to corresponding electrical signals that are provided to the first computing device 300. In doing so, the embodiments of FIGS. 5-8 provide a mechanism for confirming the existence of optical paths between networking and/or computing devices that were historically unavailable.

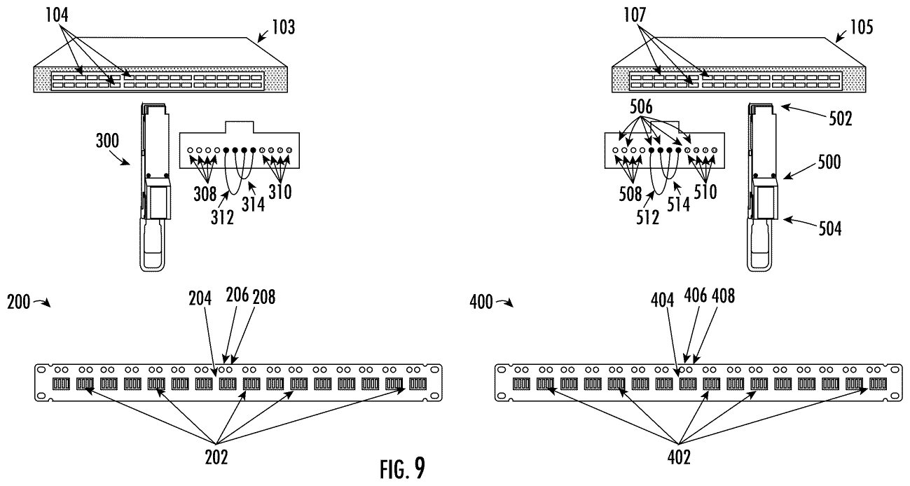

With reference to FIGS. 9-12, an example system with optical transceivers 300, 500 having multiple dark fiber pairs 312, 314, 512, 514 is illustrated prior to connection. The components of the system of FIGS. 9-12 are substantially the same as those in FIGS. 5-8 but include additional dark fiber pairs and connection indication elements. As shown in FIG. 9, the first optical transceiver 300 may include a first pair of dark fibers forming a first optical loop 312 and a second pair of dark fibers forming a second optical loop 314, and the second optical transceiver 300 may include a first pair of dark fibers forming a first optical loop 512 and a second pair of dark fibers forming a second optical loop 514. The first patch panel 200 may further include a second connection indication element 208 configured to indicate the presence of an optical path between the first patch panel 200 and one or more components associated with a second patch panel 400 (e.g., the second optical transceiver 500 or the like). The second patch panel 400 may include a fourth connection indication element 408 configured to indicate the presence of an optical path between the second patch panel 400 and the one or more components associated with the first patch panel (e.g., the first optical transceiver 300 or the like).

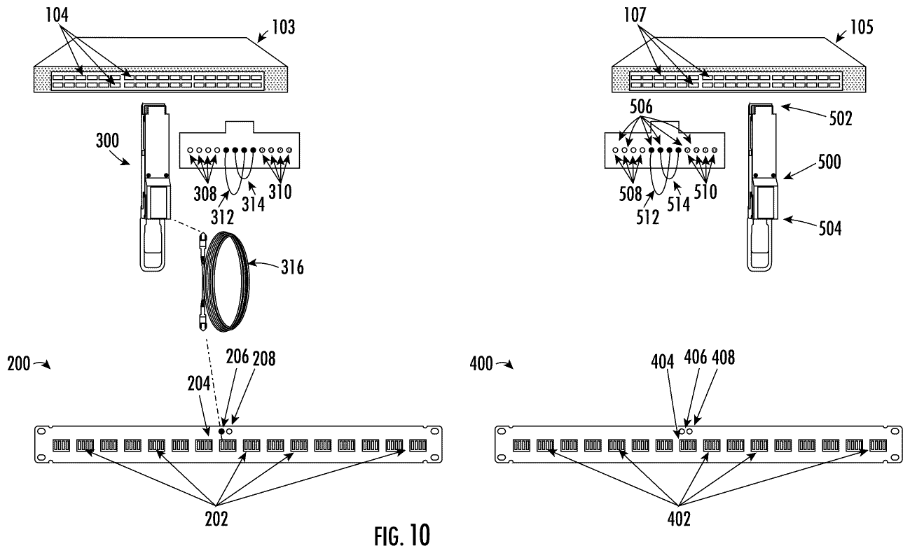

As shown in FIG. 10, the first optical transceiver 300 may be optically coupled with the first optical communication medium 316 (e.g., a connection between the second end of the first optical transceiver 300 and the first end of the first optical communication medium 316). The second end of the first optical communication medium 316 may be optically coupled with the first panel port 204 of the first patch panel 200. The first end of the first optical transceiver 300 may be optically coupled with a first connection 104 of the first computing device 103 so as to establish an optical link or connectivity between the first patch panel 200 and the first computing device 103. The first light source 210, the first light detection device 212, and the first microcontroller 214 may operate as described above with reference to FIG. 6 to cause the first connection indication element 206 to indicate the presence of an optical path between the first optical transceiver 300 and the first patch panel 200.

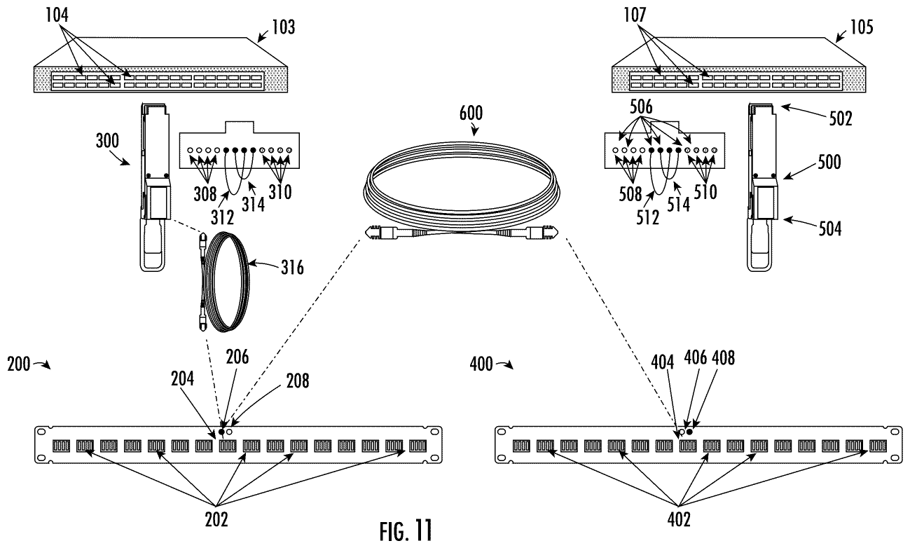

As shown in FIG. 11, the trunk cable 600 may be connected between the first panel port 204 of the first patch panel 200 and the first panel port 404 of the second patch panel 400. In order to facilitate the indication of optical connectivity between patch panels, the trunk cable 600 may include one or more dark fibers. As described above with reference to FIG. 4, the dark fibers of the trunk cable 600 may refer to any optical communication medium that is capable of transmitting light but is not used to transmit optical signals (e.g., light encoding underlying data). A light source, light detection device, and microcontroller of the second patch panel 400 may be optically coupled with the trunk cable 600 and may cause the fourth connection indication element 408 to indicate the presence of an optical path between the first optical transceiver 300 and the second patch panel 400. Alternatively, in an instance in which the second optical transceiver 500 is initially connected between the second computing device 105, and the second patch panel and the trunk cable 600 connects the first patch panel 200 and the second patch panel 400, the second connection indication element 208 (e.g., via similar operations by the first microcontroller 214) may indicate the presence of an optical path between the second optical transceiver 500 and the first patch panel 200.

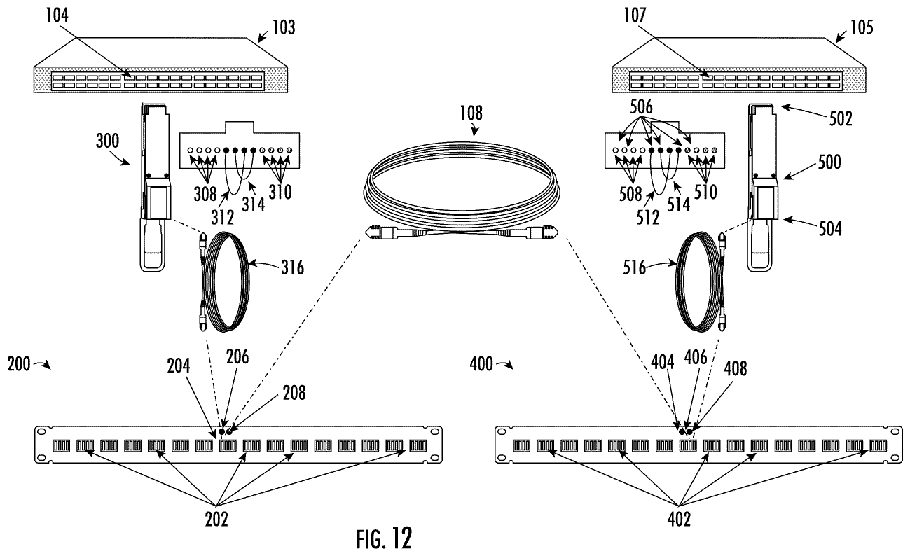

Thereafter, as shown in FIG. 12, the second optical transceiver 500 may be optically coupled with the second optical communication medium 516 (e.g., a connection between the second end of the second optical transceiver 500 and the first end of the first optical communication medium 516). The second end of the second optical communication medium 516 may be optically coupled with the first panel port 404 of the second patch panel 400. The first end of the second optical transceiver 500 may be optically coupled with a first connection 107 of the second computing device 105 so as to establish an optical link or connectivity between the second patch panel 400 and the second computing device 105. The third connection indication element 406 may be configured to indicate the presence of an optical path between the second optical transceiver 500 and the second patch panel 400. Given that the trunk cable 600 is illustrated connecting the first patch panel 200 and the second patch panel 400, the second connection indication element may also operate to indicate the presence of an optical path between the first patch panel 200 and the second optical transceiver 500. In doing so, the embodiments of the present disclosure operate to further provide optical path connectivity indications between a plurality of computing device, optical transceivers, and/or patch panels which were historically unavailable. The present disclosure contemplates that the order in which the components described with reference to FIGS. 5-12 are connected may vary, and the connection indication elements of the various patch panels 200, 400 may equally vary in response.

Many modifications and other embodiments of the present disclosure will come to mind to one skilled in the art to which these embodiments pertain having the benefit of the teachings presented in the foregoing descriptions and the associated drawings. Although the figures only show certain components of the methods and systems described herein, it is understood that various other components may also be part of the disclosures herein. In addition, the method described above may include fewer steps in some cases, while in other cases may include additional steps. Modifications to the steps of the method described above, in some cases, may be performed in any order and in any combination.

Therefore, it is to be understood that the embodiments are not to be limited to the specific embodiments disclosed and that modifications and other embodiments are intended to be included within the scope of the appended claims. Although specific terms are employed herein, they are used in a generic and descriptive sense only and not for purposes of limitation.

1. A system comprising:
a first optical transceiver;
a first optical communication medium defining:
a first end configured to be connected with the first optical transceiver; and
a second end opposite the first end;
a first patch panel comprising one or more panel ports, wherein a first panel port of the first patch panel is configured to be connected with the second end of the first optical communication medium; and
a first connection indication element configured to indicate the presence of an optical path between the first optical transceiver and the first patch panel in an instance in which the first optical transceiver is optically coupled with the first patch panel via the first optical communication medium.

2. The system according to claim 1, further comprising a first computing device or first networking switch comprising one or more connections, wherein a first connection of the first computing device or the first networking switch is configured to be connected with the first optical transceiver.

3. The system according to claim 2, wherein the first connection indication element is configured to indicate the presence of the optical path between the first computing device or the first networking switch and the first patch panel in an instance in which the first optical transceiver is optically coupled with the first patch panel via the first optical communication medium.

4. The system according to claim 1, further comprising:
at least one optical fiber configured for transmitting optical signals;
at least one optical fiber configured for receiving optical signals; and
a first pair of dark fibers forming a first optical loop.

5. The system according to claim 4, wherein the first connection indication element is configured to indicate the presence of the optical path between the first optical transceiver and the first patch panel in response to light supplied to the first pair of dark fibers forming the first optical loop.

6. The system according to claim 4, wherein the first patch panel further comprises:
a first light source optically coupled with the first pair of dark fibers forming the first optical loop;
a first light detection device coupled with the first pair of dark fibers forming the first optical loop; and
a first microcontroller communicably coupled with the first light source and the first light detection device and configured to determine the presence of the optical path between the first optical transceiver and the first patch panel.

7. The system according to claim 6, wherein the first microcontroller is configured to:
cause the first light source to emit light into the first pair of dark fibers;
cause the first connection indication element to indicate the presence of an optical path between the first optical transceiver and the first patch panel in response to receipt of the emitted light by the first light detection device.

8. The system according to claim 1, wherein the first connection indication element is further configured to:
display a first indication state associated with an absence of the optical path between the first optical transceiver and the first patch panel; and
display a second indication state associated with the presence of the optical path between the first optical transceiver and the first patch panel.

9. The system according to claim 1, wherein the first connection indication element is defined by the first patch panel.

10. The system according to claim 1, further comprising a second connection indication element configured to indicate the presence of an optical path between the first patch panel and one or more components associated with a second patch panel.

11. The system according to claim 4, further comprising a second pair of dark fibers forming a second optical loop, wherein the second optical loop is associated with determination of the presence of an optical path between the first patch panel and one or more components associated with a second patch panel.

12. The system according to claim 1, further comprising:
a second optical transceiver;
a second optical communication medium defining:
a first end configured to be connected with the second optical transceiver; and
a second end opposite the first end;
a second patch panel comprising one or more panel ports, wherein a first panel port of the second patch panel is configured to be connected with the second end of the second optical communication medium;
a third connection indication element configured to indicate the presence of an optical path between the second optical transceiver and the second patch panel in an instance in which the second optical transceiver is optically coupled with the second patch panel via the second optical communication medium; and
a jumper cable configured to optically connect the first patch panel and the second patch panel.

13. The system according to claim 12, further comprising a second computing device or second networking switch comprising one or more connections, wherein a first connection of the second computing device or the second networking switch is configured to be connected with the second optical transceiver.

14. The system according to claim 12, further comprising:
at least one optical fiber configured for transmitting optical signals;
at least one optical fiber configured for receiving optical signals;
a first pair of dark fibers forming a first optical loop associated with determination of the presence of the optical path between the first patch panel and the first optical transceiver; and
a second pair of dark fibers forming a second optical loop associated with determination of the presence of the optical path between the first optical transceiver and the second optical transceiver.

15. The system according to claim 14, further comprising:
a second connection indication element of the first patch panel configured to indicate the presence of an optical path between the first patch panel and the second optical transceiver; and
a fourth connection indication element of the second patch panel configured to indicate the presence of an optical path between the second patch panel and the first optical transceiver.

16. A patch panel comprising:
one or more panel ports, wherein a first panel port of the patch panel is configured to be connected with a second end of a first optical communication medium, and wherein a first end of the first optical communication medium opposite the second end is configured to be connected with the first optical transceiver; and
a first connection indication element configured to indicate the presence of an optical path between the first optical transceiver and the first patch panel in an instance in which the first optical transceiver is optically coupled with the first patch panel via the first optical communication medium.

17. The patch panel according to claim 16, further comprising
a first light source optically coupled with a first pair of dark fibers forming a first optical loop;
a first light detection device coupled with the first pair of dark fibers forming the first optical loop; and
a first microcontroller communicably coupled with the first light source and the first light detection device and configured to determine the presence of the optical path between the first optical transceiver and the first patch panel.

18. The patch panel according to claim 16, wherein the first connection indication element is further configured to:
display a first indication state associated with an absence of the optical path between the first optical transceiver and the first patch panel; and
display a second indication state associated with the presence of the optical path between the first optical transceiver and the first patch panel.

19. The patch panel according to claim 16, further comprising a second connection indication element configured to indicate the presence of an optical path between the first patch panel and one or more components associated with a second patch panel.

20. The patch panel system according to claim 16, wherein the first optical transceiver is further connected with a first computing device or first networking switch comprising one or more connections such that the first connection indication element is further configured to indicate the presence of the optical path between the first computing device or the first networking switch and the first patch panel in an instance in which the first optical transceiver is optically coupled with the first patch panel via the first optical communication medium.
